(19) United States
(12) Patent Application Publication
(10) Pub. No.: US 2010/0186756 A1
(43) Pub. Date: Jul. 29, 2010

(54) MOUTH GUARD AND PROCESS FOR PRODUCING THE SAME

(75) Inventors: Hiroyasu Koizumi, Tokyo (JP); Takayuki Miyahara, Tokyo (JP)

Correspondence Address: JORDAN AND HAMBURG LLP, 122 EAST 42ND STREET, SUITE 4000, NEW YORK, NY, 10168, US

(73) Assignee: NIHON UNIVERSITY, CHIYODA-KY, TOKYO (JP)

(21) Appl. No.: 12/667,009

(22) PCT Filed: Jun. 26, 2008
(86) PCT No.: PCT/JP2008/001670

§ 371 Date: Dec. 28, 2009

(30) Foreign Application Priority Data
Jun. 27, 2007 (JP) 2007-169666

(51) Int. Cl. A61C 5/14; B29C 39/12

(52) U.S. Cl. 128/861; 264/16

(57) ABSTRACT

A mouth guard with a uniform shape adapts to occlusion shapes and fits closely to teeth at an occlusion position. The mouth guard is attached to a maxillary tooth row. The mouth guard is formed from a continuous pore high-polymer material to have a characteristic that includes a plateau region of a stress to a compression strain. The mouth guard utilizes the characteristic to fit closely to the tooth rows at the occlusion portion between upper and lower tooth rows, to apply even stress to the tooth rows contacting the occlusion portion. As this result, the mouth guard provides an excellently close-fitting degree and high safety owing to high impact absorption power.

### BACKGROUND OF THE INVENTION

The present invention relates to a mouth guard which has a portion attached to at least a maxillary tooth row, and in particular to a mouth guard which is improved in close-fitting degree to tooth rows by employing a porous material.

There are conventional mouth guards to be used in various sports such as boxing and American football. Various types of mouth guards are known as the conventional mouth guards (see Patent Literatures 1 and 2). Such mouth guard is attached to at least a maxillary tooth row to reduce an impact applied from outside and protect teeth, gums supporting the teeth and additionally jaw joints. Incidentally, the “mouth guard” is also called “mouthpiece”, “splint” or the like.

Further, the mouth guard worn by a user lies at an occluding portion of the user to serve as an occlusion stabilizing portion. The occlusion stabilizing portion makes it easier for the user to clench the teeth and helps the user to put some muscle.

Such a mouth guard must conform with the shape of the inside of a user's mouth, so that there is a mouth guard shaped by a bite of a user after softening with heat or the like. There is also a mouth guard shaped from a denture mold made by a dentist or the like.

Such a mouth guard is made of a material such as silicone rubber or ethylvinyl acetate (EVA) which is impact-resistant and has sufficient strength.

However, these materials have a linear stress-strain relationship, so that there is a problem of incompatibility between impact absorbability that is sacrificed if an elastic coefficient is increased to form a stable occlusion stabilizing portion and a suitable occlusion stabilizing portion that is difficult to be formed if an elastic coefficient is set to be low to some extent to increase impact absorbability.
Patent Literature 1: Japanese Patent Application Laid-Open Publication No. H11-42311
Patent Literature 2: Japanese Patent Application Laid-Open Publication No. 2003-102748

### SUMMARY OF THE INVENTION

A problem to be solved lies in the incompatibility between impact absorbability that is sacrificed for forming a suitable occlusion stabilizing portion and a suitable occlusion stabilizing portion that is difficult to be formed if impact absorbability is intended to be increased.

A mouth guard according to a first aspect of the present invention comprises a front wall portion covering a front side of a tooth row, a rear wall portion covering a rear side of the tooth row, and an occlusion portion which connects the front wall portion and the rear wall portion to each other and on which occlusion of maxillary and mandibular tooth rows is performed. The front wall portion, the rear wall portion and the occlusion portion are formed from a porous material with flexibility and impact absorbability. The occlusion portion deforms according to occlusion force between the maxillary and mandibular tooth rows to increase in density in a cross-section in an occluding direction in comparison to the front wall portion and the rear wall portion such that an occlusion stabilizing portion is formed to fit closely to the maxillary and mandibular tooth rows.

In a mouth guard according to a second aspect of the present invention, the porous material is a continuous pore high-polymer material.

In a mouth guard according to a third aspect of the present invention, the continuous pore high-polymer material includes a high-polymer framework material that is thermoplastic styrene series elastomer.

In a mouth guard according to a fourth aspect of the present invention, the occlusion portion has a different porosity to the front wall portion and the rear wall portion.

In a mouth guard according to a fifth aspect of the present invention, the porosity of the occlusion portion is set to be lower than those of the front wall portion and the rear wall portion, or the occlusion portion is formed from a porous material different from the front wall portion and the rear wall portion.

In a mouth guard according to a sixth aspect of the present invention, the occlusion portion includes an intermediate portion in a thickness direction, and the intermediate portion is formed by setting the porosity to be low relatively to the remaining portion or by an embedded material set to be hard relatively to the remaining portion.

In a mouth guard according to a seventh aspect of the present invention, the front the wall portion, the rear wall portion and the occlusion portion have inner faces contacting the tooth row and outer faces not contacting the tooth rows, respectively, and porosities of the inner faces are set to be higher than those of the outer faces, or the a side of the inner faces are formed from a porous material with low rigidity while a side of the outer faces are formed from a porous material with high rigidity relative to the inner faces.

In a mouth guard according to an eighth aspect of the present invention, the occlusion portion has an even thickness.

In a mouth guard according to a ninth aspect of the present invention, the occlusion portion is formed in a spherical shape corresponding to a spherical surface including a curve of Spee and a curve of Wilson.

In a mouth guard according to a tenth aspect of the present invention, at least one of the front wall portion and the rear wall portion has a Kolben-like sectional shape in which a distal end is swollen and rounded.

A process according to the present invention for producing the mouth guard of any of the foregoing aspects of the present invention comprises steps of, filling a mold for a mouth guard with mixture of dissolvable pore forming material and molding material, removing the mixture molded by the filling from the mold, and treating the molded and removed mixture with solvent to dissolve and remove the dissolvable pore forming material, thereby obtaining a continuous pore material.

The mouth guard of the first aspect of the present invention comprises a front wall portion covering a front side of a tooth row, a rear wall portion covering a rear side of the tooth row, and an occlusion portion which connects the front wall portion and the rear wall portion to each other and on which occlusion of maxillary and mandibular tooth rows is performed. The front wall portion, the rear wall portion and the occlusion portion are formed from a porous material with flexibility and impact absorbability. The occlusion portion deforms according to occlusion force between the maxillary and mandibular tooth rows to increase in density in a cross-section in an occluding direction in comparison to the front wall portion and the rear wall portion such that an occlusion stabilizing portion is formed to fit closely to the maxillary and mandibular tooth rows.

Therefore, the mouth guard has a plateau region generated in a stress-strain characteristic of a porous material, so that the occlusion portion deforms following the shapes of the tooth rows to fit closely to the tooth rows with no clearance. As this result, it can form an occlusion stabilizing portion whose density in the cross-section in the occluding direction is high relatively to those of the front wall portion and the rear wall portion in the occlusion portion.

Therefore, the mouth guard can be bitten by the occlusion between the maxillary and mandibular tooth rows to be held securely. Further, it can securely absorb impact from a front side by the front wall portion utilizing the plateau region effectively.

Further, when the mouth guard is clenched strongly or clenched on receipt of impact by the maxillary and mandibular tooth rows, the stress-strain characteristic of the occlusion stabilizing portion tends to shift away from a range of the plateau region. As this result, impact absorbability is rapidly enhanced to secure impact absorption. At the same time, the density of the occlusion stabilizing portion in the cross-section in the occluding direction is also rapidly increased according to the impact or the like, so that the suitable and stabilized occlusion stabilizing portion can be formed immediately according to the impact.

That is, the mouth guard can achieve compatibility between formation of a suitable occlusion stabilizing portion and securing of impact absorbability.

In the mouth guard of the second aspect of the present invention, the porous material is a continuous pore high-polymer material.

Therefore, it can secure the plateau region of the stress-strain characteristic due to the characteristic embodied by what the pores are continuous. It can obtain more reliably the effect according to the first aspect of the invention.

In the mouth guard of the third aspect of the present invention, the continuous pore high-polymer material includes a high-polymer framework material that is thermoplastic styrene series elastomer.

Therefore, the mouth guard can be obtained to be suitable for a human body.

In the mouth guard of the fourth aspect of the present invention, the occlusion portion has a different porosity to the front wall portion and the rear wall portion.

Therefore, it can select optimum porosities suitable for stresses acting on the occlusion portion, the front wall portion and the rear wall portion, so that the mouth guard can achieve compatibility between stability of the occlusion stabilizing portion and impact absorbability more reliably.

In the mouth guard of the fifth aspect of the present invention, the porosity of the occlusion portion is set to be lower than those of the front wall portion and the rear wall portion, or the occlusion portion is formed from a porous material different from the front wall portion and the rear wall portion.

Therefore, the mouth guard can increase impact absorbability at the front wall portion and the like while the stability of the occlusion stabilizing portion is enhanced by a stress-strain characteristic appropriate for stress to high occlusion force at the occlusion portion.

In the mouth guard of the sixth aspect of the present invention, the occlusion portion includes an intermediate portion in a thickness direction, and the intermediate portion is formed by setting the porosity to be low relatively to the remaining portion or by an embedded material set to be hard relatively to the remaining portion.

Therefore, the occlusion portion can adjust to the high stress to high occlusion force while the contacting portion can obtain a longer plateau region of the stress-strain characteristic according to unevenness of the tooth rows.

In the mouth guard of the seventh aspect of the present invention, the front wall portion, the rear wall portion and the occlusion portion have inner faces contacting the tooth row and outer faces not contacting the tooth row, respectively, and porosities of the inner faces are set to be higher than those of outer faces, or a side of the inner faces is formed from a porous material with low rigidity while a side of the outer faces is formed from a porous material with high rigidity relative to the inner faces.

Therefore, it can improve shape maintaining ability of the mouth guard, as this result, the front wall portion and the rear wall portion can improve a close-fitting degree with respect to faces of the tooth rows.

In a mouth guard of the eighth aspect of the present invention, the occlusion portion has an even thickness.

Therefore, the mouth guard can make a mold simply, so that molding cost is reduced.

In a mouth guard of the ninth aspect of the present invention, the occlusion portion is formed in a spherical shape corresponding to a spherical surface including a curve of Spee and a curve of Wilson.

Therefore, the mouth guard can improve the close-fitting degree due to the curving face of the occlusion portion corresponding to the spherical shape of the tooth rows and extending along the curve of Spee and the curve of Wilson is formed.

In a mouth guard of the tenth aspect of the present invention, at least one of the front wall portion and the rear wall portion has a Kolben-like sectional shape in which a distal end is swollen and rounded.

Therefore, the swelled distal end portion is held on the inside of a lip, so that the mouth guard is prevented from coming off by itself.

A process according to the present invention for producing the mouth guard of any one of the foregoing aspects of the present invention recited in claim 11 comprises steps of, filling a mold for a mouth guard with mixture of dissolvable pore forming material and molding material, removing the mixture molded by the filling from the mold, and treating the molded and removed mixture with solvent to dissolve and remove the dissolvable pore forming material, thereby obtaining a continuous pore material.

Therefore, the method can manufactures the mouth guard that reliably achieves compatibility between stability of the occlusion stabilizing portion and impact absorbability.

### BRIEF DESCRIPTION OF THE DRAWINGS

FIG. 1 is a perspective view showing a mouth guard (Embodiment 1);

FIG. 2 is a sectional view showing the mouth guard in an attached state (Embodiment 1);

FIG. 3 is a plan view showing the mouth guard in an attachment state (First embodiment);

FIG. 4 is a stress-strain diagram showing a fully-dense elastic body and a porous body (Embodiment 1);

FIG. 5 is a scanning electron micrograph showing a continuous pore high-polymer material (Embodiment 1);

FIG. 6(A) is an operation explanatory view of a mouth guard made of fully-dense elastic material, and FIG. 6(B) is an operation explanatory view of the mouth guard made of the porous material (Embodiment 1);

FIG. 7 is an explanatory view showing a curve of Spee (Embodiment 1);

FIG. 8 is an explanatory view showing a curve of Wilson (Embodiment);

FIGS. 9(A) and 9(B) illustrate a shape of a bottom face of the mouth guard formed according to a spherical surface conforming with the curve of Spee and the curve of Wilson, in which FIG. 9(A) is an oblique projection view showing the mouth guard from the rear side and FIG. 9(B) is a side view showing the mouth guard (Embodiment 1);

FIG. 10 is a flowchart indicating steps showing a mouth guard manufacturing method;

FIG. 11 is a sectional view showing a mouth guard (Embodiment 2);

FIG. 12 is a sectional view showing a mouth guard (Embodiment 3);

FIG. 13 is a sectional view showing a mouth guard (Embodiment 4);

FIG. 14 is a sectional view showing a mouth guard (Embodiment 5); and

FIG. 15 is a sectional view showing a distal end of a front wall portion (Embodiment 6).

### DETAILED DESCRIPTION OF THE INVENTION

The object that impact absorbability can be increased while a suitable occlusion stabilizing portion can be formed is realized by utilizing a porous material for a mouth guard.

### Embodiment 1

[Shape and Material of Mouth Guard]

Hereinafter, embodiments of the present invention will be explained with reference to the drawings.

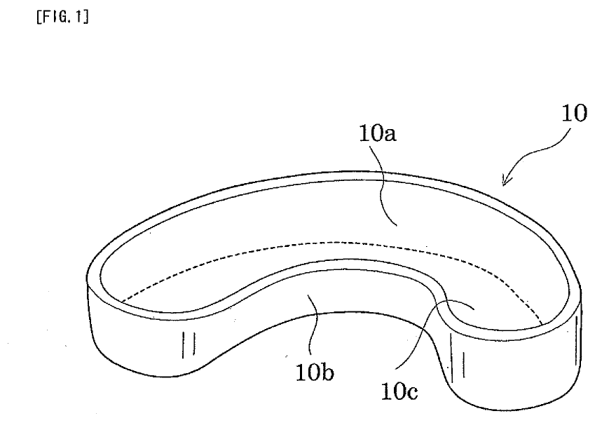

FIG. 1 is a perspective view showing a mouth guard 10 according to the embodiment 1. The mouth guard 10 is attached to a maxillary tooth row of a user so as to cover the maxillary tooth row. This mouth guard 10 comprises a front wall portion 10a covering a front side of the tooth row, a rear wall portion 10b covering a rear side thereof, and an occlusion portion 10c positioned at an occluding portion between the maxillary tooth row and the mandibular tooth row. The front wall portion 10a and the rear wall portion 10b constitute wall portions of the mouth guard 10, and they are continuous with each other in an arc shape at end portions in directions toward back teeth.

In this embodiment, the front wall portion 10a, the rear wall portion 10b and the occlusion portion 10c are formed to have the same constant thickness. Though occluding portions between the upper teeth and the lower teeth have uneven faces, the mouth guard 10 of this embodiment deforms to adapt to the unevenness by clenching the teeth through that mouth guard 10. Therefore, the mouth guard 10 itself has no problem with the occlusion portion 10c having a flat-plate shape with a constant thickness, and the mouth guard 10 can adapt to various shapes of occluding portions which are different for different people.

Incidentally, the front wall portion 10a, the rear wall portion 10b and the occlusion portion 10c may be formed to have different thicknesses from one another. Further, it may vary a thickness within each portion of the front wall portion 10a, the rear wall portion 10b and the occlusion portion 10c in a longitudinal direction and in a width direction of the portion.

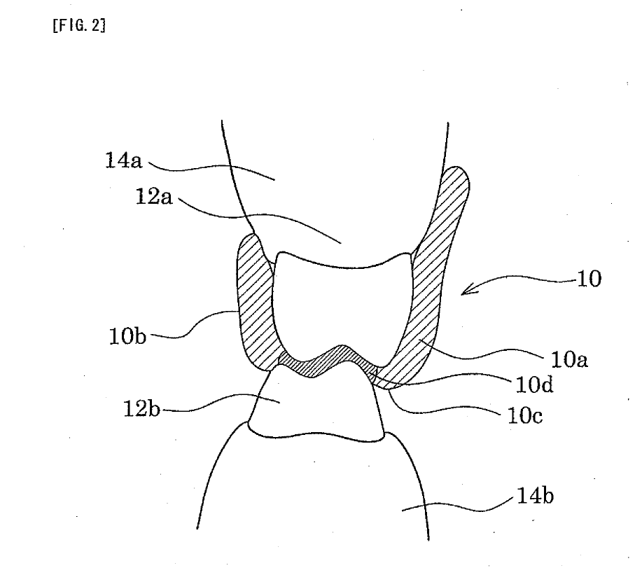

In the first embodiment, the height of the front wall portion 10a is set to be slightly higher than that of the rear wall portion 10b (see FIG. 1 and FIG. 2). The heights of the front wall portion 10a and the rear wall portion 10b may be the same height as shown in the following embodiments.

The mouth guard 10 can be worn by various users due to its elasticity. In terms of size, however, it is preferable to prepare about three sizes of small, medium and large sizes to allow a user to use it according to his/her size.

Further, the shape of a space surrounded by the front wall portion 10a, the rear wall portion 10b and the occlusion portion 10c may be set to be smaller than a general size of a tooth row in consideration for compressibility of the front wall portion 10a and the rear wall portion 10b. With this configuration, the mouth guard 10 may be attached and fit closely to a tooth row.

Further, the shape of a space surrounded by the front wall portion 10a, the rear wall portion 10b and the occlusion portion 10c may be formed to conform with a general shape of a tooth row and set to be slightly smaller than the general shape of a tooth row.

The mouth guard 10 is made of a continuous pore high-polymer material in this embodiment. As this material, for example, “SAPOROUS” as a registered trademark made by Asahi Rubber Inc. are known, in which thermoplastic styrene series elastomer is used as framework high-polymer, for example. In a case that a relatively-hard material is desired, various kinds of thermoplastic resin may be used as the framework high-polymer.

Regarding physical specifications of the continuous pore high-polymer material of the mouth guard 10, the following physical specifications are employed for example.

(i) The continuous pore high-polymer material made by extrusion molding and having a thickness of 3 mm has a physical specification identified by: a specific gravity of a porous body: 0.26; a porosity [%]: 73; a hardness (JIS K7312, SRIS0101, t12 mm) (Asker C): 25; a pull strength (JIS K6253, dumbbell-like No. 3 type, a pulling rate of 500 mm/min) [MPa]: an extruding direction of 0.560, a width direction of 0.460; a stretch (JIS K6253, dumbbell-like No. 3 type, a pulling rate of 500 mm/min) [%]: an extruding direction of 100, a width direction of 200; a tear strength (JIS K6252, unnotched angle tyep) [N/mm %]: 3.0; a rate of impact absorption ((the maximum acceleration in a case of blank—the maximum acceleration in a case of presence of a material)/the maximum, acceleration in a case of blank, t3.6 mm) [%]: 54; a modulus of rebound resilience (JIS K6400, a steel ball with a diameter of ⅝ inches falling freely, t=12 mm) [%]: 15; an air permeation rate (JIS L1096 air permeability “A” method, Frazier type tester, t3 mm) [cm³/cm²·s]: 0.1; a moisture permeation rate (with reference to JIS Z1504, 40° C., t2 mm) [g/cm²·24 h]: 4.120; and a rate of compressive residual strain (50° C.×22 h, 50% compression, t20 mm, measured 30 minutes later) [%]: 45.

(ii) The continuous pore high-polymer material made by extrusion molding and having a thickness of 2 mm has a physical specification identified by: a specific gravity of a porous body: 0.29; a porosity [%]: 71; a hardness (JIS K7312, SRIS0101, t12 mm) (Asker C): 48; a pull strength (JIS K6253, dumbbell-like No. 3 type, a pulling rate of 500 mm/min) [MPa]: an extruding direction of 0.930, a width direction of 0.820; a stretch (JIS K6253, dumbbell-like No. 3 type, a pulling rate of 500 mm/min) [%]: an extruding direction of 200, a width direction of 250; a tear strength (JIS K6252, unnotched angle type) [N/mm %]: 3.7; a rate of impact absorption ((the maximum acceleration in a case of blank—the maximum acceleration in a case of presence of a material)/the maximum acceleration in a case of blank, t3.6 mm) [%]: 51; a modulus of rebound resilience (JIS K6400, a steel ball with a diameter of ⅝ inches is made to fall naturally, t=12 mm) [%]: 23; an air permeation rate (JIS L1096 air permeability A method, Frazier type tester, t3 mm) [cm³/cm²·s]: 0.1; a moisture permeation rate (refer to JIS 21504, 40° C., t2 mm) [g/cm²·24 h]: 4.100; and a rate of compressive residual strain (50° C.×22 h, 50% compression, t20 mm, measured 30 minutes later) [%]: 25.

[Attachment of Mouth Guard and Occlusion Stabilizing Portion]

The mouth guard must conform with the shape of the inside of a user's mouth, and there is a mouth guard as a custom product shaped from a denture mold made by a dentist generally. There is also a mouth guard as a universal product shaped by a bite of a user after softening with heat or the like generally.

The custom product can fit closely but it increases the cost. The universal product reduces the cost but it cannot be close-fitting enough. Further, in the universal mouth guard, shape deformation caused by elastic deformation of the mouth guard does not follow unevenness of the tooth rows to generate a clearance between tooth rows and the mouth guard. Further, the universal mouth guard receives particular large force on a tooth top side of tooth rows, so that the universal mouth guard cannot distribute impact absorption power over the whole tooth rows. Further, the universal mouth guard deteriorates a close-fitting degree and the like.

On the other hand, the mouth guard 10 of this embodiment is formed from the continuous pore high-polymer material having elasticity. Therefore, the mouth guard 10 has elasticity and a plateau region as mentioned later, so that the mouth guard without casting can have a close-fitting degree that is the same or more than that of the custom product by simply attaching.

FIG. 2 is a cross-section showing the mouth guard attached to a tooth row of a user. As shown in FIG. 2, there is a maxillary tooth 12a on a maxillary gum 14a and there is a mandibular tooth 12b on a mandibular gum 14b. Faces of the maxillary tooth 12a and the mandibular tooth 12b facing each other have recesses at central portions and are shifted back and forth such that concavities and convexities on both faces mesh with each other.

Then, the occlusion portion 10c of the mouth guard 10 receives pressure and deforms with tooth clenching of a user.

The occlusion portion 10c (occluded portion) is formed into a plate to have an approximately-constant thickness. The occlusion portion 10c is compressed by occlusion force, so that the density of the continuous pore high-polymer material is increased relatively to the front wall portion 10a and the rear wall portion 10b. As this result, the occlusion portion 10c deforms to follow the shapes of the upper and lower teeth according to the occlusion faces of the maxillary tooth row and the mandibular tooth row, to form an occlusion stabilizing portion 10d (FIG. 2).

Additionally, the mouth guard 10 fits to the tooth rows, that is, the whole of the maxillary gum 14a, the maxillary tooth 12a, the mandibular gum 14b and the mandibular tooth 12b along their front and rear faces as shown in FIG. 2.

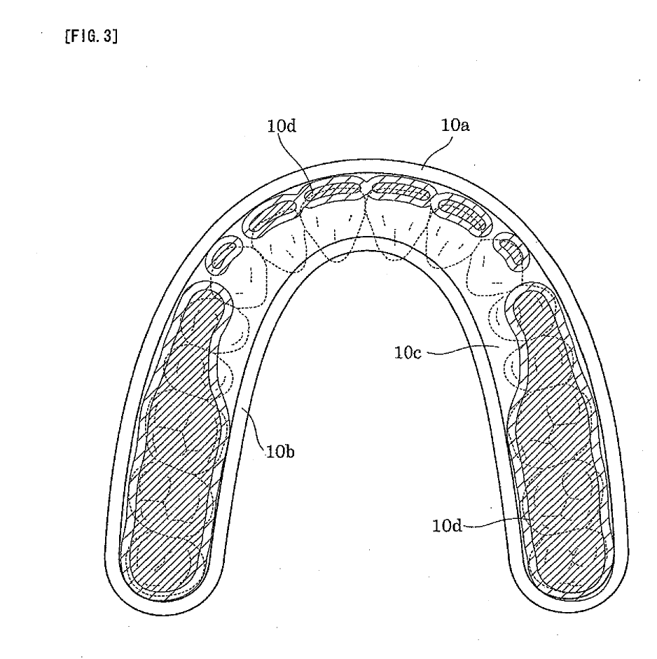

FIG. 3 is a plan view showing the mount guard observed from above. FIG. 3 illustrates formation of the occlusion stabilizing portion 10d. In the occlusion portion 10c of the mouth guard 10, the continuous pore high-polymer material is compressed at the occluding portion between upper and lower tooth rows (the mandibular tooth row is shown by dotted lines, the maxillary tooth row is omitted) by occlusion force of the tooth rows. As this result, the density is increased to form the occlusion stabilizing portion 10d. With the formation of the occlusion stabilizing portion 10d, deviation of the mouth guard is eliminated or suppressed. In the occlusion stabilizing portion 10d, central portions whose densities are relatively high due to application of strong occlusion force and peripheral portions whose densities are relatively low due to application of week occlusion force are shown differently by different hatching densities.

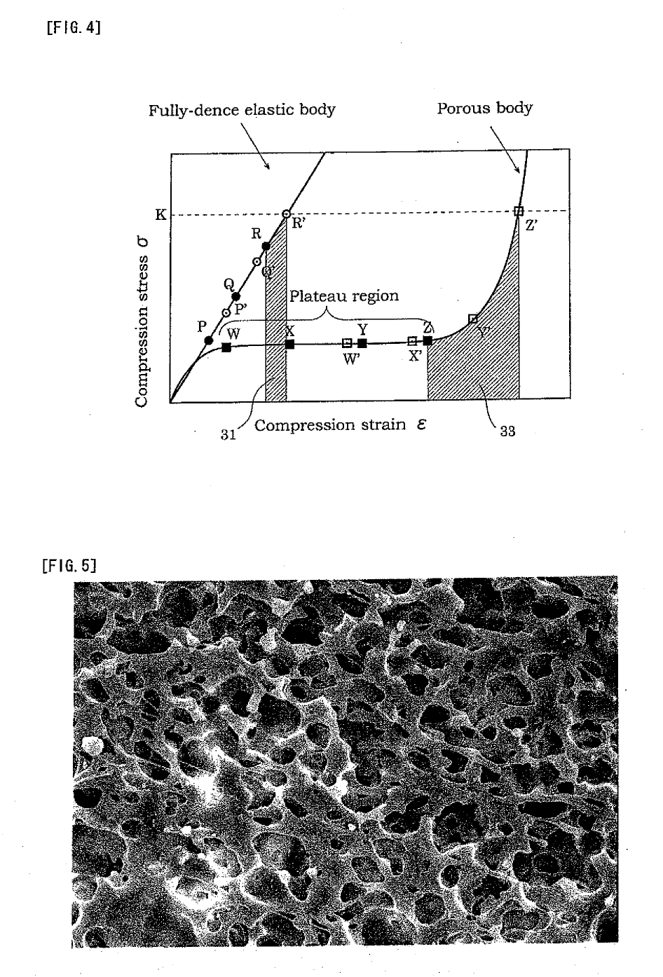

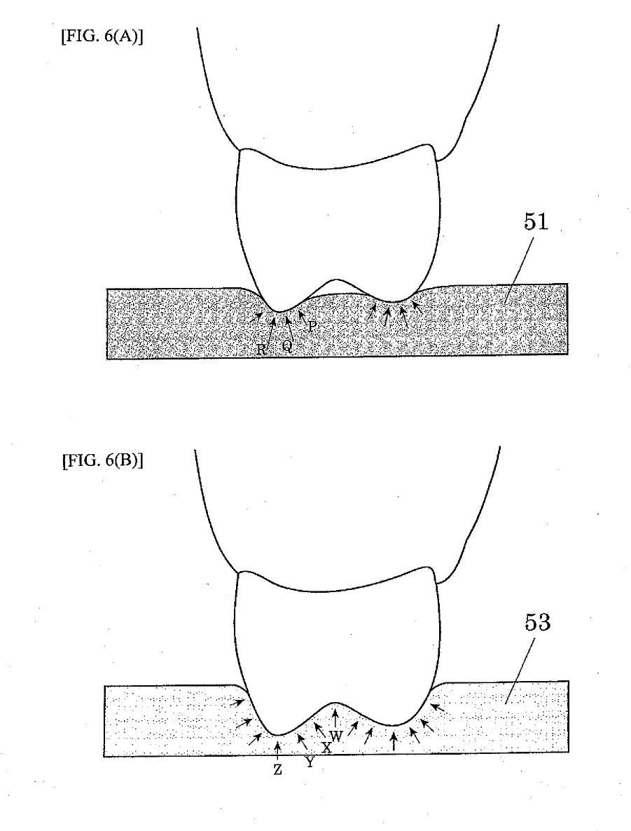

In the occlusion stabilizing portion 10d, it is preferable to design a stress-strain characteristic of the continuous pore high-polymer material such that the mouth guard 10 attached to and naturally bitten by a user (before clenched strongly, or before clenched on impact) receives a stress that is positioned within a range of the plateau region of a curve of the stress-strain characteristic at a portion whose density is increased by the compression with a tooth top of a tooth row (Z point in FIG. 6(B); Z point in FIG. 4).

This design is realized by sample survey of users to obtain occlusion force at a time of attaching and naturally biting the mouth guard 10.

Incidentally, another design may be adopted according to demand. For example, it may adopt a design that a stress at a portion where a strain amount in a compression state with a natural bite is maximum is deviated from a range of the plateau region.

[Stress-Strain Characteristic of Porous Material]

FIG. 4 is a difference in stress-strain characteristic between a fully-dense elastic body such as silicon rubber or ethylvinyl acetate (EVA) used for a conventional mouth piece and a porous body such as continuous pore high-polymer material used for this embodiment of the present invention.

In the fully-dense elastic body, a stress-strain relationship is a linear relationship (P, Q, and R), but in the porous body, a stress-strain relationship has a plateau region (W, X, Y, and Z) where the strain is gradually increased while the stress is approximately constant after reaching a given value.

This plateau region is dependent on a microstructural characteristic of the porous body.

FIG. 5 is a scanning electron micrograph showing the porous body of the continuous pore high-polymer material. The porous body has a sponge-like structure where microscopic pores exist as shown. The plateau region corresponds to a region in which the volumes of these pores are getting reduced (the density of the porous body is increased). In the plateau region, increase of required stress is small until hollow pores are crushed or until the middle of crushing the pores. When the strain deviates from a range of the plateau region after the pores are crushed or after the middle of crushing the pores, the stress is rapidly increased according to increase of the strain amount.

FIGS. 6(A) and 6(B) show a difference in the stress acting on mouth guards to which above-mentioned different characteristics are applied. FIGS. 6(A) and 6(B) illustrate a normal attachment state, for example, a state that the mouth guard is attached to and naturally bitten by a user (before clenching it strongly, or before clenching it on impact). In order to explain simply, the shapes of the materials of the mouth guards are shown by flat-plate shapes instead of normal U-shapes. When a tooth is brought down (clenched) to each of the flat-plate-like fully-dense body 51 and porous body 53 from above, differences in stress acting on respective portions of teeth and deformations of the materials will be explained.

The fully-dense elastic body 51 shown in FIG. 6(A) has the above-mentioned linear stress-strain characteristic, so that the stress is sequentially and linearly increased at respective points P, Q, and R in this order of increasing the strain amount (Each of arrows of P, Q, and R shows a magnitude of the stress with the length; these magnitudes of the stress correspond to P, Q, and R points shown in FIG. 4).

In this case, if an elastic coefficient of the fully-dense elastic body 51 is set to be relatively high to increase stability of the occlusion stabilizing portion, large force (R) is applied to a tooth top of a tooth row. In the normal attachment state, occlusion force is limited. The fully-dense elastic body 51 does not fit closely to the tooth row any more to generate a clearance, and this results in an unstable occlusion stabilizing portion. Even this fully-dense elastic body 51 may fit closely to the tooth row if an elastic coefficient is set to be relatively low. However, magnitudes of the stress remain different at the respective points, so that the occlusion stabilizing portion is unstable in this point and this lowers impact absorbability due to a low elastic coefficient.

On the other hand, in the porous body 53 shown in FIG. 6(B), the stress of an approximately-constant magnitude acts at respective points W, X, Y, and Z (correspond to the W, X, Y, and Z in FIG. 4 similarly) in this order of increasing the strain amount due to the presence of the plateau region regardless of the magnitude (Z (large) and W (small), for example) of the strain. Therefore, the porous body is strained suitably to follow a shape of a tooth by constant occlusion force, so that a suitable occlusion stabilizing portion is formed to fit closely to the whole tooth row without a clearance.

Impact absorption power when a large impact is applied to both the materials will be explained with reference to FIG. 4 again. When impact force K in an occluding direction is applied, or when the teeth are clenched strongly regardless of presence or absence of applied impact, the fully-dense elastic body 51, which has already been positioned at point R at a tooth top of a tooth row due to the occlusion force, is strained to point R′. An impact absorption power at this time is expressed by the area of a hatched region 31.

On the other hand, in such a case in which the impact force K is applied to the porous body similarly, a tooth top Z of the tooth row, which has been in the range of the plateau region, is deviated from the range of the plateau region and shifted to Z′ point. An impact absorption power at this time is expressed by the area of a hatched region 33.

As apparent from comparison between the areas of these hatched regions 31 and 33, the impact absorbability of the mouth guard 10 of this embodiment is relatively higher. Further, the formation of the occlusion stabilizing portion 10d is maintained at the time of impact absorption.

Further, when the mouth guard 10 receives impact force from the front side, the front wall portion 10a can absorb the impact from a point of a small strain in the range of the plateau region up to a point of a generated strain. The front wall portion 10a can provide high impact absorbability. When the front wall portion 10a performs such impact absorption, the porous body strains largely in a cross-section in the occluding direction due to clenching as mentioned above. This results in absorbing the impact due to the area of the hatched region 33 and forming the stable and suitable occlusion stabilizing portion 10d.

In this way, the mouth guard 10 with the plateau region can form the stable occlusion stabilizing portion 10d and fit closely to the whole tooth rows due to the even stress without a clearance at a normal state (in a state in which the mouth guard does not receive an impact and is bitten with moderate force). At the same time, the mouth guard 10 can obtain large impact absorption power when it receives an impact.

In addition, clenching pressure (force for occlusion) when a person clenches the teeth varies among different individuals. In this embodiment, however, the mouth guard deforms according to the force for occlusion. In particular, the mouth guard 10 has elasticity and impact absorption power to be able to set an end point of the deformation to a suitable thickness according to the forces for occlusions of respective person. This end point is a point positioned in the range of the plateau region including points W, X, Y, and Z expressed in the stress-strain characteristic with respect to respective portions of the tooth row, as shown in FIG. 4.

The conventional mouth guard employs general plastic (such as silicon rubber or ethylvinyl acetate) with the characteristic having no plateau region. The mouth guard is not flexible but hard to have the constant thickness, so that it causes back teeth to be damaged after clenching the mouth guard strongly and repeatedly. In contrast, the mouth guard 10 of this embodiment can eliminate such a defect due to the low stress mentioned above.

In this way, in the mouth guard 10 of this embodiment, an end point at which a user occludes for attachment can coincide with the end point of the plateau region (Z point) according to differences in clenching pressure among individuals. The point becomes the most suitable occluding thickness for the user, so that it can provide a user with a suitable mouth guard 10.

Additionally, it is often required to clench back teeth strongly in order to put some muscle in such a sport dependent on instantaneous force. In this case, teeth are directly clenched to receive large force thereon. As this result, too much force may be applied to gums, or the back teeth receiving the large force may grind with each other.

The mouth guard 10 of this embodiment that is attached in the mouth can reduce impact force applied to the teeth and the gums with the impact absorbability and elasticity thereof. In addition, the mouth guard 10 can receive sufficient occlusion force at the clenching end point, to put some muscle sufficiently. Therefore, it can reduce an adverse effect to the teeth and the gums while putting some muscle sufficiently.

According to this embodiment, the continuous pore high-polymer material has air permeability and water absorbability. Therefore, the continuous pore high-polymer material does not bring discomfort when it is attached in the mouth. That is, the continuous pore high-polymer material has continuous pores, and the mouth guard 10 can make saliva or the like pass through the pore and hold some saliva inside. Thereby, saliva is not accumulated between the mouth guard 10 and the gums, so that the mouth guard 10 can provide a comfortable fit. Saliva is transferred to/from a tongue, so that the mouth guard can provide a further comfortable fit. Furthermore, as described above, it is possible to make the impact absorbability sufficient.

In addition, styrene elastomer is the high-polymer framework of the porous material having no toxicity to biological bodies, so that it is very suitable as material put on in the mouth.

[Curve of Spee, Curve of Wilson]

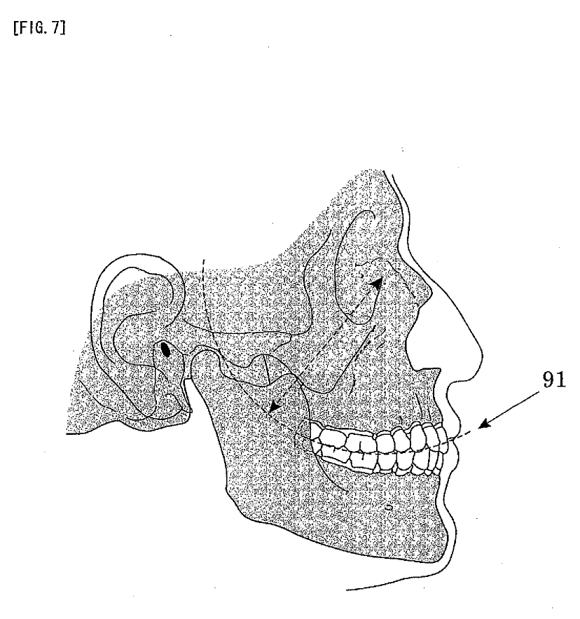

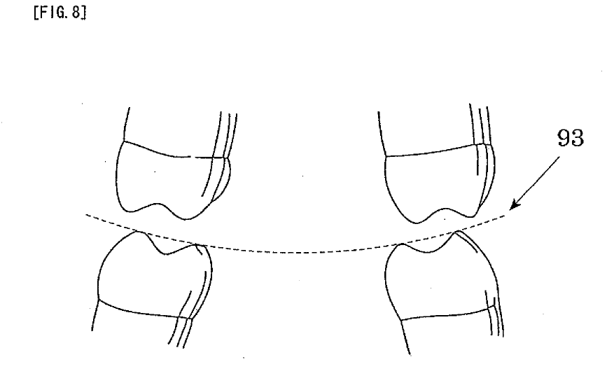

Preferably, the occlusion portion 10c of the mouth guard 10 is formed into a spherical surface. This is because the occluding portion of the teeth of a person extends along an arc centering about an eye as shown in a side view of FIG. 7 viewed from the side (called “curve of Spee” 91). Further, this is also because arrangements of maxillary and mandibular posterior teeth extend along an arc having the center above the teeth as shown in FIG. 8 which is viewed from the front or the rear side (called “curve of Wilson” 93).

Therefore, the occluding portion configures a part of a whole spherical surface swelling downward.

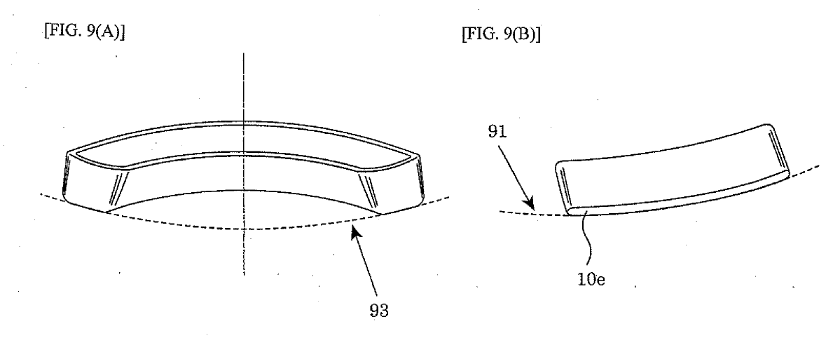

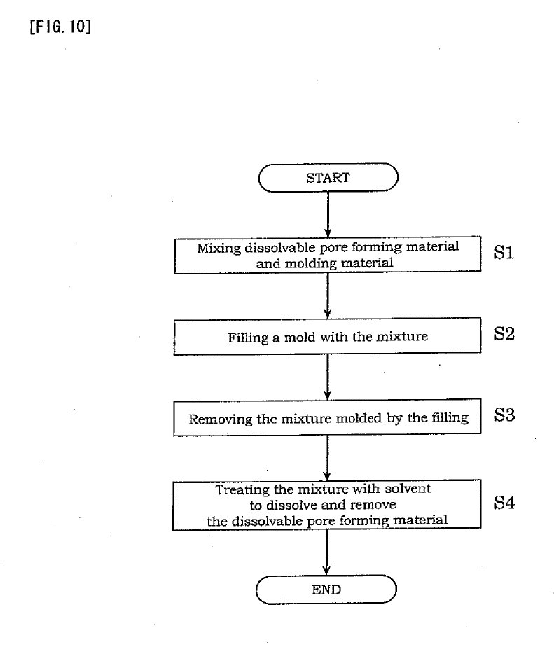

Then, as shown in FIG. 9(A) (oblique view of the mouth guard from the rear side) and FIG. 9(B) (side view of the mouth guard), the occlusion portion 10c is formed into a spherical shape corresponding to the spherical surface defined by the curve of Spee 91 and the curve of Wilson 93 as a whole including a bottom face 10e, to make the mouth guard 10 conform with the part of the spherical surface. The mouth guard 10 can provide an excellent close-fitting degree according to the spherical shape of the occlusion portion 10c.

The mouth guard 10 of this embodiment is manufactured by injection molding or extrusion molding. FIG. 10 is a flowchart illustrating steps of a manufacturing method of the mouth guard of this embodiment.

The method of manufacturing the mouth guard 10 of this embodiment includes a step (S1) of mixing dissolvable pore forming material and molding material, a step (S2) of filling a mold for the mouth guard with the mixture of the dissolvable pore forming material and molding material mixed at the mixing step (S1), a step (S3) of removing the mixture molded by the filling from the mold, and a step (S4) treating the molded and removed mixture with solvent to dissolve and remove the dissolvable pore forming material, thereby obtaining a continuous pore material.

For more detail, the dissolvable pore forming material and framework high-polymer material (molding material) are mixed by a predetermined ratio (S1).

The pore forming material and the framework high-polymer material are mixed in their fluid states and introduced into an injection molding machine or the like. Incidentally, the mixing ratio between the pore forming material and the framework high-polymer material may vary according to target porosity.

The mold for the mouth guard is filled with the mixture of the pore forming material and the framework high-polymer (S2), and a solid molded product can be obtained by demolding thereafter (S3). This solid molded product includes the pore forming material as it is and is not porous. Then, the solid molded product obtained by demolding is treated with solvent to dissolve and remove the dissolvable pore forming material in the solvent (S4), thereby obtaining the mouth guard 10 with continuous pores.

Incidentally, the solvent may vary depending on pore forming material and framework high-polymer and may be, for example, water, various alcohol or the like.

In this way, the shaped mouth guard 10 is provided with predetermined air permeability and water permeability. Styrene-series continuous pore high-polymer material described above has relatively small pores to also have water absorbability.

### Embodiment 2

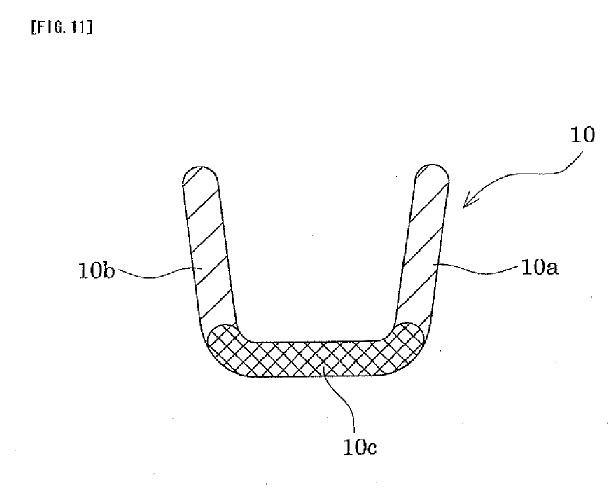

FIG. 11 is a sectional view showing a mouth guard according to an embodiment 2 of the present invention.

As shown in FIG. 11, relatively-soft material is used for the front wall portion 10a and the rear wall portion 10b of the moth guard 10, while relatively-hard material is used for the occlusion portion 10c. This variation in hardness may be realized by changing framework high-polymers. As described in Patent Literature 3, large variety of high-polymer material can be utilized, and such change of materials can be carried out easily.

Further, the variation in hardness can also be realized by changing porosities. This may be carried out by uniting materials different in porosity with each other, or by reducing the pore forming material at a portion corresponding to the occlusion portion 10c without mixing the pore forming material and the framework high-polymer material evenly. Though the material before molded has fluidity, it is not runny like water so that it is easy to bias the material to some extent. In this way, the mouth guard 10 can be provided with the occlusion portion 10c that has the low porosity and is relatively hard.

Furthermore, the variation in hardness may be achieved by changing a mixture ratio of two materials mixed with each other during injecting the materials into the mold. Conditions in which the materials are introduced into the mold can be estimated from simulations or the like or can be obtained from experimental results through a trial and error process. Therefore, it can control injection to the mold to form the mouth guard 10 in which high-polymer materials having different hardness or different porosity are used in different portions.

In this embodiment, operation and effect similar to the embodiment 1 can be achieved. Further, it can form the occlusion stabilizing portion 10d more properly.

### Embodiment 3

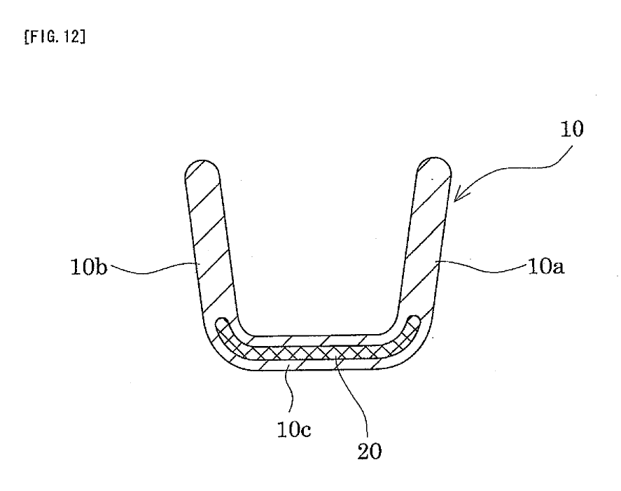

FIG. 12 is a sectional view showing a mouth guard according to an embodiment 3 of the present invention.

As shown in FIG. 12, it has an intermediate portion 20 embedded in the occlusion portion 10c and made of a relatively-hard material as compared to other portions. This structure can be realized by controlling inject the materials at the molding. The intermediate portion 20 is positioned in the middle portion in a thickness direction (an occluding direction) of the occlusion portion 10c.

The intermediate portion 20 may be realized by reducing the porosity thereof.

This embodiment hardens the occlusion portion 10c to be clenched by the teeth in the mouth guard 10 relatively to the front wall portion 10a and the rear wall portion 10b. Therefore, the strength of the occlusion portion 10c to be clenched with large force is increased, while the mouth guard 10 holds to fit softly to gums and provides a comfortable fit. It can provide a user with comfort at the time of clenching, and the occlusion stabilizing portion 10d is supported by the intermediate portion 20 that is made of the different material or has the low porosity, so that the mouth guard can help a user to put some muscle.

### Embodiment 4

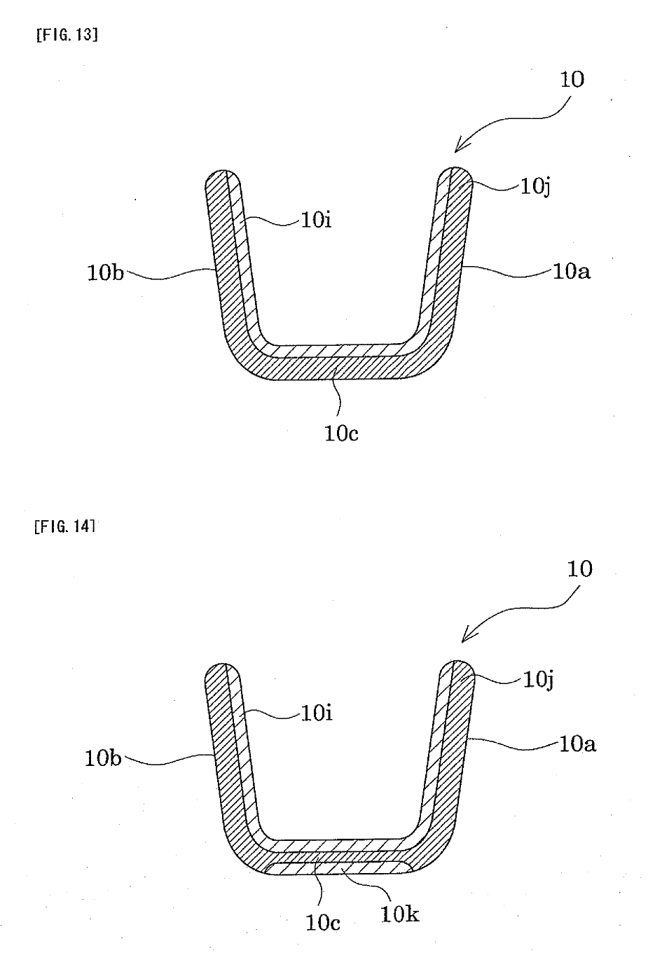

FIG. 13 is a sectional view showing a mouth guard according to an embodiment 4 of the present invention.

As shown in FIG. 13, the mouth guard of this embodiment has an inner face portion 10i that fits closely to a tooth row. The inner face portion 10i has rigidity (hardness) set to be lower than that of an outer face portion 10j. This may be realized by two porous materials having different rigidities and stuck together. Further, this may be realized by two materials having different porosities (porosity of the inner face portion set to be high, porosity of the outer face portion set to be low) stuck together. Furthermore, this may be realized by a material whose porosity is biased by such a method as described in the second embodiment.

This embodiment can improve shape maintaining ability of a mouth guard. The shape is maintained by the outer face portion 10j with high rigidity, so that the inner face portion 10i comes in contact with a tooth row with suitable stress. As a result, the mouth guard can improve the close-fitting degree with respect to the tooth row.

### Embodiment 5

FIG. 14 is a sectional view showing a mouth guard according to an embodiment 5 of the present invention.

As shown in FIG. 14, in addition to the embodiment 4, it has a contact portion 10k to a mandibular tooth row. The contact portion 10k is set to be relatively low in rigidity similarly to the inner face portion 10i to improve the close-fitting degree.

Similarly to the inner face portion 10i of the embodiment 4, the contact portion 10k can be realized by different materials, materials having different porosity, or a material with sequentially-changing porosity in the thickness direction.

Thereby, it can improve in close-fitting degree at the contact face to the mandibular tooth row as well.

### Embodiment 6

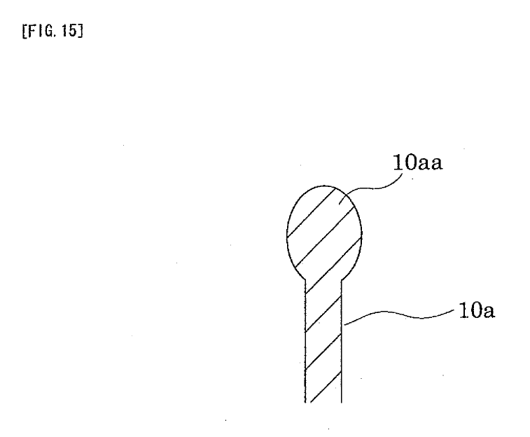

FIG. 15 is a sectional view showing a distal end of a front wall portion according to a mouth guard of an embodiment 6 of the present invention.

As shown in FIG. 15, the front wall portion 10a has a sectional shape formed into totally a Kolben-like shape in which a distal end portion 10aa is swollen and rounded. Thereby, the swelled distal end portion 10aa is held between the lip and the gums so that it effectively prevents the mouth guard from coming off.

The mouth guard 10 of this embodiment can be also formed by injection molding or extrusion molding with the mold as mentioned above, so that the mouth guard 10 which adapts to a shape of a tooth row of a user can be mass-produced.

In this way, the mouth guard 10 according to this embodiment can adapt to many people with its approximately-fixed shape, so that it can be available as a marketed product at sporting-goods stores and the like. Unlike conventional material products, it is unnecessary for the mouth guard 10 to fix its shape according to individuals and the mouth guard 10 can greatly reduce the cost. Therefore, the mouth guard 10 is an extremely-attractive product not only for hospitals and doctors but also for the general public.

[Other Constitutions]

(Regarding the Shape of a Mouth Piece)

(a) The mouth guard may have another preferable shape that covers the whole front sides of teeth deeply and covers inner sides of teeth considerably shallowly such that the teeth are exposed from the rear sides. In this case, the mouth guard can reduce an uncomfortable feeling on the rear side of the teeth while sufficiently absorbing impact applied from outside.

(b) The mouth guard may have still another preferable shape that the front wall portion 10a positioned on the front sides of the teeth is set to be thicker than the rear wall portion 10b positioned on the inner sides thereof. In this case, similarly to the above, the mouth guard can reduce an uncomfortable feeling on the rear sides of the teeth while sufficiently absorbing impact applied from outside.

(c) The mouth guard may have still another preferable shape that the thickness of the occlusion portion 10c to be clenched between upper and lower teeth is set to be different between a portion to be clenched by back teeth and a portion to be clenched by front teeth. By thinning the occlusion portion 10c on the back tooth side, the mouth guard 10 is made easy to clench as a whole.

1. A mouth guard comprising a front wall portion covering a front side of a tooth row, a rear wall portion covering a rear side of the tooth row, and an occlusion portion which connects the front wall portion and the rear wall portion to each other and which is disposed in an occluding portion between maxillary and mandibular tooth rows, wherein
the front wall portion, the rear wall portion and the occlusion portion are formed from a porous material with flexibility and impact absorbability that has a plateau region in a stress-strain characteristic, and
the occlusion portion has a given thickness and is clenched to deform according to occlusion force between the maxillary and mandibular tooth rows and increase in density in a cross-section in an occluding direction relative to the front wall portion and the rear wall portion such that an occlusion stabilizing portion is formed within a range of the plateau region to fit closely to the maxillary and mandibular tooth rows and is deformable to absorb impact so as to shift away from the range of the plateau region according to the impact.

2. The mouth guard according to claim 1, wherein
the porous material is continuous pore high-polymer material.

3. The mouth guard according to claim 2, wherein
the continuous pore high-polymer material includes high-polymer framework material that is thermoplastic styrene series elastomer.

4. The mouth guard according to any one of claims 1 to 3, wherein
the occlusion portion has a different porosity to the front wall portion and the rear wall portion.

5. The mouth guard according to claim 4, wherein
the porosity of the occlusion portion is set to be lower than those of the front wall portion and the rear wall portion, or the occlusion portion is formed from a porous material different from those of the front wall portion and the rear wall portion.

6. The mouth guard according to any one of claims 1 to 3, wherein
the occlusion portion includes an intermediate portion in a thickness direction, and the intermediate portion is formed by setting the porosity to be low relatively to the remaining portion or by an embedded material set to be hard relatively to the remaining portion.

7. The mouth guard according to any one of claims 1 to 3, wherein
the front wall portion, the rear wall portion and the occlusion portion have inner faces contacting the tooth row and outer faces not contacting the tooth row, respectively, and
porosities of the inner faces are set to be higher than those of the outer faces, or a side of the inner faces is formed from a porous material with low rigidity while a side of the outer faces is formed from a porous material with high rigidity relative to the inner faces.

8. The mouth guard according to any one of claims 1 to 3, wherein
the occlusion portion has an even thickness.

9. The mouth guard according to any one of claims 1 to 3, wherein
the occlusion portion has a spherical shape corresponding to a spherical . surface including a curve of Spee and a curve of Wilson.

10. The mouth guard according to any one of claims 1 to 3, wherein
at least one of the front wall portion and the rear wall portion has a Kolben-like sectional shape in which a distal end is swollen and rounded.

11. A method of manufacturing the mouth guard according to any one of claims 1 to 3, comprising:
filling a mold for the mouth guard with mixture of dissolvable pore forming material and molding material;
removing the mixture molded by the filling from the mold; and
treating the molded and removed mixture with solvent to dissolve and remove the dissolvable pore forming material, thereby obtaining a continuous pore material.
